(19) United States
(12) Patent Application Publication
(10) Pub. No.: US 2025/0066520 A1
(43) Pub. Date: Feb. 27, 2025

(54) Propylene Ethylene Random Copolymer Having Low Hexane Extractable and Xylene Soluble

(71) Applicant: Formosa Plastics Corporation, U.S.A., Livingston, NJ (US)

(72) Inventors: Gapgoung Kong, Sugarland, TX (US); Chih-Jian Chen, Port Lavaca, TX (US); Min-Chi Hsieh, Port Lavaca, TX (US); Lei Zhang, Port Lavaca, TX (US); Cyrus C.Y. Lee, Victoria, TX (US)

(21) Appl. No.: 18/454,204

(22) Filed: Aug. 23, 2023

(51) Int. Cl. C08F 210/16

(52) U.S. Cl. CPC C08F 210/16; C08F 2800/20

(57) ABSTRACT

The present invention relates to a phthalate free propylene-ethylene copolymer having high ethylene content characterized by low hexane extractable and xylene soluble properties, while showing excellent mechanical properties. The preparation of the copolymer is carried out in the presence of a phthalate free catalyst system comprising (a) phthalate free catalyst component obtained by contacting a magnesium halide, a titanium compound having at least a Ti-halogen bond and one or more electron donor compounds comprising urea, a carbonate ether, and a 1,3-diether; (b) an alkyl aluminum compound; and (c) an external electron donor compound.

### BACKGROUND

The present invention relates to phthalate free propylene-ethylene copolymers. In particular, the present invention provides propylene-ethylene random copolymers having high ethylene content, characterized by low hexane extractable and xylene soluble properties, while also showing excellent mechanical properties.

It is well known in the art that the preparation process for propylene-ethylene copolymer comprises introducing one or more copolymerization into the propylene polymerization process. In particular, it is useful to decrease the crystallinity of the propylene polymer by copolymerization of the propylene with small quantities (0.5-7% wt) of ethylene. In this manner, one obtains the so called random crystalline propylene copolymers which are essentially characterized by better flexibility and transparency. These materials can be used in many application sectors, such as, for example irrigation pipes, pipes for transporting drinking water and other liquid food, heating equipment, single layer bottles (for detergents), multilayer bottles (for beverages), single layer or multilayer film for various packaging, and rigid food containers.

Propylene ethylene random copolymer is used in food packaging applications where low hexane extractable or xylene soluble of propylene ethylene random co-polymer has been required. Furthermore, there had been growing demand for phthalate free polypropylene (co)polymers due to environmental and health safety concerns. U.S. Pat. Nos. 9,068,928 and 9,068,029 disclose impact resistant propylene polymers produced by a phthalate free catalyst containing internal donors comprising a magnesium halide, titanium compound having succinate, and 1.3-diether as internal donors. Recently, U.S. Pat No. 9,815,920 discloses a catalyst component containing a urea component, which can produce highly crystalline polypropylene with high activity. Furthermore, U.S. Publ. App. 2021/0102011 discloses phthalate free propylene polymer having high flexural modulus with high melt flow, which are produced by a Ziegler-Natta type catalyst containing internal donors comprising urea, carbonate ether, and 1,3-diether.

As such, there still remains a desire for a phthalate free propylene ethylene random co-polymers having less hexane extractable or xylene soluble portion, specially, in the food packaging application area.

### SUMMARY OF INVENTION

The present invention relates to a phthalate free propylene-ethylene copolymer having high ethylene content characterized by low hexane extractable and xylene soluble properties, while showing excellent mechanical properties. The preparation of the copolymer is carried out in the presence of a phthalate free catalyst system comprising (a) phthalate free catalyst component obtained by contacting a magnesium halide, a titanium compound having at least a Ti-halogen bond and one or more electron donor compounds comprising urea, a carbonate ether, and a 1,3-diether; (b) an alkyl aluminum compound; and (c) an external electron donor compound.

A phthalate free random copolymer of propylene with ethylene is provided, the copolymer having a melt flow rate in the range of about 6.0 to about 20 g/10 min; and an ethylene content in the range of about 3.0 to about 5.0% by weight; wherein the hexane extractable portion of the copolymer is less than 2.0%; and wherein the xylene soluble portion of the copolymer is less than 4.5%. The copolymer has a flexural modulus is in the range of about 140 to about 160 Kpsi.

Yet another phthalate free random copolymer of propylene with ethylene is provided, the copolymer having a melt flow rate in the range of about 6.0 to about 20 g/10 min; and an ethylene content in the range of about 5.0 to about 6.0% by weight; wherein the hexane extractable portion of the copolymer is less than 3.0%; and wherein the xylene soluble portion of the copolymer is less than 9.0%. The copolymer has a flexural modulus is in the range of about 80 to about 90 Kpsi.

### DETAILED DESCRIPTION OF INVENTION

The present invention relates to phthalate free propylene-ethylene copolymers. In particular, the present invention provides propylene-ethylene random copolymers having high ethylene content, characterized by low hexane extractable and xylene soluble properties, while showing excellent mechanical properties.

In a preferred embodiment of present invention, propylene-ethylene random co-polymers are produced using a catalyst system comprising a phthalate free Zeigler-Natta (ZN) catalyst component (a), alkylaluminum component (b), and optionally an external electron donor component (c).

The phthalate free ZN catalyst components (a) are produced using well known techniques by contacting titanium chloride with magnesium ethoxide in the presence of one or more internal electron donors comprising 1,3-diether, carbonate ether, and urea compounds.

Examples of 1,3-diether compounds include, but are not limited to: 2-(2-ethylhexyl)1,3-dimethoxypropane, 2-isopropyl1,3-dimethoxypropane, 2-butyl-1,3-dimethoxypropane, 2-sec-butyl-1,3-dimethoxypropane, 2cyclohexyl-I,3-dimethoxypropane, 2-phenyl-I,3-dimethoxypropane, 2-tert-butyl-1,3dimethoxypropane, 2-cumyl-I,3-dimethoxypropane, 2-(2-phenylethyl)-I,3-dimethoxypropane, 2,2-diethyl-I,3-diethoxypropane, 2,2-dicyclopentyl-1,3-dimethoxypropane, 2,2-dipropyl-I,3-diethoxypropane, 2,2-dibutyl-1,3-diethoxypropane, 2-methyl-2-ethyl-1,3-dimethoxypropane, 2-methyl-2-propyl-I,3-dimethoxypropane, 2-methyl-2-benzyl-I,3-dimethoxypropane, 2,2diphenyl-I-dimethoxypropane, 2,2-dibenzyl-I,3-dimethoxypropane, 2-isopropyl-2cyclopentyl-I,3-dimethoxypropane, 2,2-bis(cyclohexylmethyl)-I,3-dimethoxypropane, 2,2-diisobutyl-I,3-diethoxypropane, 2,2-diisobutyl-I,3-dibutoxypropane, 1,I-bis(methoxymethyl)-7-(3,3,3-trifluoropropyl)indene, 1,1-bis(methoxymethyl)-7-trimethyisilylindene; 1,1-bis(methoxymethyl)-7-trifluoromethylindene, 1,1-bis(methoxymethyl)-4,7-dimethyl-4,5,6,7tetrahydroindene, 1,I-bis(methoxymethyl)-7-methylindene, 1,I-bis(methoxymethyl)-1Hbenz[e]indene, 1,I-bis(methoxymethyl)-1H-2-methylbenz[e]indene, 9,9bis(methoxymethyl)fluorene, 9,9-bis(methoxymethyl)-2,3,6,7-tetramethylfluorene, 9,9bis(methoxymethyl)-2,3,4,5,6,7-hexafluorofluorene, 9,9-bis(methoxymethyl)-2,3-benzofluorene, 9,9-bis(methoxymethyl)-2,3,6,7-dibenzofluorene, 9,9-bis(methoxymethyl)-2,7diisopropylfluorene, 9,9-bis(methoxymethyl)-1,8-dichlorofluorene, 9,9-bis(methoxymethyl)-2,7dicyclopentylfluorene, 9,9-bis(methoxymethyl)-1,8-difluorofluorene, 9,9-bis(methoxymethyl)-1,2,3,4-tetrahydrofluorene, 9,9-bis(methoxymethyl)-1,2,3,4,5,6,7,8-octahydrofluorene, and 9,9bis(methoxymethyl)-4-tert-butylfluorene.

Examples of carbonate ether include, but are not limited to: (2-methoxyethyl) methyl carbonate, (2-ethoxyethyl) methyl carbonate, (2-propoxyethyl) methyl carbonate, (2-butoxyethyl) methyl carbonate, (2-(2-ethoxyethyloxy)ethyl) methyl carbonate, (2-benzyloxyethyl) methyl carbonate, (2-methoxypropyl) methyl carbonate, (2-ethoxypropyl) methyl carbonate, (2-methyl-2methoxybutyl) methyl carbonate, (2-methyl-2-ethoxybutyl) methyl carbonate, (2-methyl-2methoxypentyl) methyl carbonate, (2-methyl-2-ethoxypentyl) methyl carbonate, (I-phenyl-2methoxypropyl) methyl carbonate, (2-methoxyethyl) ethyl carbonate, and (2-ethoxyethyl) ethyl carbonate.

Examples of urea compounds represented by Formula I include, but are not limited to: N,N,N′,N′-tetramethylurea, N,N,N′,N′tetraethylurea, N,N,N,N′-tetrapropyllurea, N,N,N′N′-tetrabutylurea, N,N,N′N′tetrapentylurea, N,N,N′,N′-tetrahexylurea, N,N,N′,N′-tetra(cyclopropyl)urea, N,N,N′,N′tetra(cyclohexyl)urea, N,N,N′,N′-tetraphenylurea, bis(butylene)urea, bis(pentylene)urea, N,N′dimethylethyleneurea, N,N′-dimethylpropyleneurea, N,N′-dimethyl(2-(methylaza)propylene)urea and N,N′-dimethyl(3-(methylaza)pentylene)urea, n-amyltriphenylurea, n-hexyltriphenylurea, noctyltriphenylurea, n-decyltriphenylurea, n-octadecyltriphenylurea, n-butyltritolylurea, n-butyltrinaphthylurea, n-hexyltrimethylurea, n-hexyltriethylurea, noctyltrimethylurea, dihexyldimethylurea, dihexyldiethylurea, trihexylmethylurea, tetrahexylurea; n butyltricyclohexylurea, t-butyltriphenylurea; 1,1-bis(p-biphenyl)-3-methyl-3-n-octadecylurea; 1,1-di-n-octadecyl-3-t-butyl-3-phenylurea; I-p-biphenyl-1-methyl-3-noctadecyl 3 phenylurea; 1methyl-I-n-octadecyl-3 p-biphenyl-3-o-tolylurea; m-terphenyl-tri-t-butylurea, 1,3-dimethyl-2imidazolidinone, 1,3-diethyl-2-imidazolidinone, 1,3-dipropyl-2-imidazolidinone, 1,3-dibutyl-2imidazolidinone, 1,3-dimethyl-3,4,5,6-tetrahydro-2-pyrimidinone, and N,N-dimethyl-N,N,diphenylurea.

The alkyl aluminum compound (b) is preferably chosen among an aluminum alkyl having the formula AlR₃, where R is an alkyl having 1 to 8 carbon atoms, with the three R groups being the same or different. Examples of suitable aluminum alkyls are trimethyl aluminum (TMA), triethyl aluminum (TEAL) and triisobutyl aluminum (TIBAL). The preferred aluminum alkyl is TEAL.

Preferred external electron-donor compounds are silicon compounds having the formula R¹R²Si(OR³)ₐ, where a is an integer from 1 to 3, and where R¹, R² and R³, are alkyl, cycloalkyl or aryl radicals with 1-18 carbon atoms optionally containing heteroatoms. Particularly preferred external electron-donor compounds include, without limitation: methylcyclohexyldimethoxysilane; diphenyldimethoxysilane; methyl-t-butyldimethoxysilane; dicyclopentyldimethoxysilane; 2-ethylpiperidinyl-2-t-butyldimethoxysilane; 1,1,1trifluoropropyl-2-ethylpiperidinyl-dimethoxysilane; 1,1,1trifluoropropyl-metil-dimethoxysilane; cyclohexylmethyldimethoxysilane; cyclohexylethyldimethoxysilane; isobutylisopropyldimethoxysilane; diphenyldimethoxysilane; isobutylisopropyldimethoxysilane; phenyltriethoxysilane; 3,3,3-trifluoropropylmethyldimethoxysilane; diisopropyldimethoxysilane; octylmethyldimethoxysilane; isobutyltrimethoxysilane; isobutyltriethoxysilane; npropyltrimethoxysilane; di-t-butyldimethoxysilane; cyclopentyl 1,I-dimethyl-2,2dimethylethyldimethoxysilane; and diamino silanes such as (R₂N)₂Si(OCH₃)₂, (R₂N)₂Si(OCH₂CH₃)₂ and (piperidinyl)₂Si(OCH₃)₂. The preferred molar ratio of the external donor to titanium in the ZN catalyst is preferably about 5 to about 30, more preferably about 8 to about 15, and most preferably about 10.

It is preferable to carry out the gas phase polymerization process, where the propylene/ethylene impact copolymer is produced in a gas-phase reactor in the presence of propylene, ethylene and the catalyst system described above. The polymer produced is preferably a propylene impact copolymer containing from 0.5 to 7% wt ethylene. The compositions obtained according to the process of the present invention can be obtained as reactor grade with a Melt Flow Rate value according to ISO 1133 (230° C., 2.16 Kg) preferably ranging from about 0.01 to about 100 g/10 min, more preferably from about 0.1 to about 70 g/10 min, and most preferably from about 0.2 to about 60 g/10 min.

### EXAMPLES

In order to provide a better understanding of the foregoing, the following non-limiting examples are offered. Although the examples may be directed to specific embodiments, they are not to be viewed as limiting the invention in any specific respect.

The data of the propylene polymer materials were obtained according to the following methods:

Xylene-Soluble Fraction Calculation (FDA method): Weigh 5 g ±0.001 g of pellet sample and record as Ws to a 2-liter 4-neck flask. Weigh 1,000 ml of xylene, and record the weight to the nearest 0.1 gram (as W1). Add the xylene to the flask and reflux for 2 hours. Allow the flask to cool in air until the temperature of the contents drops to 50° C., after which the flask may be rapidly cooled to 25° C.-30° C. by immersing in a cool water bath. Transfer the flask to a constant temperature bath set to maintain 25° C.±0.1° C., and allow to equilibrate for at least 1 hour (may be left overnight if convenient). Remove the flask from the water bath, shake, and break up any precipitated polymers that may have formed. Decant the xylene solution successively through a double layered filter paper into a pre-weighed 1-liter beaker, collecting only the first 450 mls-500 mls of filtrate. Re-weigh the beaker and calculate the weight of the filtrate obtained to the nearest 0.1 gram (as W2). Transfer the filtrate to a 1-liter beaker, and apply nitrogen gas on top of the filtrate, evaporate the solvent on an electric hot-plate. When the volume of solvent in the beaker has been reduced to 100 mls, transfer the concentrated extractive to an aluminum dish that has been pre-weighed to the nearest 0.0001 gram (as B1). Rinse the beaker twice with 10-20 ml portions of fresh xylene, adding it to the aluminum dish. Evaporate the remainder of the xylene on the hot-plate set at low heat under the gas cover with a stream of nitrogen directed toward the center of the dish. Transfer the dish to a vacuum desiccator at room temperature and allow to remain under reduced pressure for at least 12 hours (overnight). Determine the net weight of the residue to the nearest 0.0001 gram (as B2).

The % Xylene Soluble=(B2-B1)×(W1+W2)/Ws×100, where:
B1: grams of aluminum dish
B2: grams of aluminum dish with residue of 4
W1: grams of 1000 ml xylene
W2: grams of 450 m is to 500 m is filtrate
Ws: grams of sample

Hexane Extractable Fraction Calculation (FDA method): Weigh out 3.0 grams of the extruded sample pellets and arrange the pellets in a on a metal plate covered with Mylar film. Sample top should also be covered with a plate and Mylar film. Heat the sample for 5 min with the low pressure off in the “Hot Press”. Transfer the sample to the “Cold Press” after the 5 min using the provided hot resistant gloves Cool the sample for 5 min (ensure that the thermostat on the cold press reads below 100° C. for the plates). Cut the film into 1″ wide slices and measure the thickness of the slices using a caliper-micrometer so that the thickness is not over 0.004″. Place the 4-neck flask in the heating mantle. Assemble the stirring system to the middle neck and the reflux condenser and thermocouple to side necks. Clamp down the flask from the metal lattice to one of the necks on the flask. Weigh 1000 ml n-Hexane by means of the top loading balance and record the weight. Then, transfer the solvent into the 2-liter flask. Start water flowing through the reflux condenser, turn on the motor stirrer to produce vigorous agitation. Turn on heating mantle with transformer to bring the temperature to 50° C. and allow the hexane to stabilize for 2 hours. Transfer 2.5 grams of the film sample (cut into approximately 1 inch square in size) to the 2-liter flask containing the tweezers. Allow the sample to reflux for 2 hours after the film sample has been added. Remove the flask from the heat, and decant the solvent, while still warm, through a coarse filter paper placed on top of glass funnel, collecting the filtrate into 1000 ml beakers. NOTE: Flask should be around 50° C. so it should be warm and should be held for less than 1 minute. Determine the weight of the filtrate recovered to the nearest gram. Recovery should be at least 90% of the original solvent. Transfer the solvent filtrate to a 1.5 L beaker. Place the beaker on a hot-plate covered with a fresh sheet of aluminum foil and invert a short-stemmed 4-inch funnel over the dish. Pass nitrogen down through the funnel at a rate sufficient to just ripple the surface of the solvent. Set the hot-plate at a suitable temperature above the boiling point of hexane. When the volume of the solvent has been reduced to about 100 ml, transfer the concentrated liquid to a weighed 200 ml aluminum pan. Wash the 1.5-liter beaker twice with 20-30 ml portions of solvent, adding the washings to the aluminum pan. Continue to evaporate the solvent on the hot-plate set at a suitable temperature under the gas cover with a stream of nitrogen directed toward the center of the aluminum pan. Transfer the aluminum pan with its residue to a vacuum desiccator, and allow it to remain overnight (at least 12 hours) under reduced pressure. Then, weigh the aluminum pan and its residue to the nearest 0.0001 gram.

MFR (Melt flow rate): MFR was evaluated by melt indexer under condition of 230° C. with 2.16 kg total weight according to ASTM D1238. Sample mass: 5 grams.

Conditioning: Specimens are tested for tensile or flexural modulus within 40 to 96 hours according to ASTM D4101 section 12.1.5.

Tensile strength at break: Specimens are injection molded to ASTM Tensile bar type I, which has specimen dimensions 165 mm total length, width of narrow section 13 mm and 3.2 mm thickness. (speed). Tensile strength was measured according to ASTM D638-10.

Flexural Modulus: Specimens are injection molded to ASTM Tensile bar type I, using type/center section for a specimen dimensions of 127 mm×13 mm×3.2 mm. Flexural Modulus determination is performed at 23±2° C. and 50±10% RH, per ASTM D790 Method 1, procedure A, (speed) 1% Secant Mod.

Izod impact: Izod impact strength was measured according to ASTM D256.

### Phthalate Free Catalyst Component

As used herein, the TFC101 catalyst is a phthalate free catalyst from Toho employing internal donors comprising 1,3-diether, carbonate ether, and urea compounds. The 1,3-diether catalyst is a commercial phthalate free catalyst employing 1,3-diether as an internal donor.

### Continuous Gas Phase Polymerization—Preparation of Phthalate Free Propylene Ethylene Random Co-Polymer.

The polymerization run in the presence of catalyst system comprising TFC101 catalyst from Toho, triethylaluminum, and silane external donor, is carried out in a continuous gas phase mode in a reactor equipped with devices to transfer the product. A propylene ethylene co-polymer is prepared in the gas phase reactor while ethylene/propylene are added in the ratio listed in the Table 1. Hydrogen is used as molecular weight regulator. The gas phase (propylene, ethylene and hydrogen) is continuously analyzed via gas-chromatography. At the end of the run the product powder is discharged and dried under a nitrogen flow. The main polymerization conditions and the analytical data relating to the polymers produced are summarized in Table 1.

### Comparative Gas Phase Polymerization—Preparation of Propylene Ethylene Random Co-Polymer.

The polymerization run in the same way as above with catalyst system comprising 1,3-diether catalyst which is commercially available, and silane external donor, is carried out in a continuous gas phase mode in a reactor equipped with devices to transfer the product. A propylene ethylene co-polymer is prepared in the gas phase reactor while ethylene/propylene are added in the ratio listed in the Table 1. Hydrogen is used as molecular weight regulator. The gas phase (propylene, ethylene and hydrogen) is continuously analyzed via gas-chromatography. At the end of the run the product powder is discharged and dried under a nitrogen flow. The main polymerization conditions and the analytical data relating to the polymers produced are summarized in Table 1.

TABLE 1
Propylene ethylene random Copolymer produced
from Continuous Gas phase polymerization

| | Example | | | Comparative Example | | |
|---|---|---|---|---|---|---|
| Catalyst | TFC101 catalyst | | | 1,3-diether catalyst | | |
| MFR | 11 | 12 | 6.4 | 10 | 11 | 6.9 |
| C2 | 3.40% | 3.70% | 5.30% | 3.10% | 3.30% | 5.50% |
| Tc (° C.) | 110 | 119 | 101 | 109 | 122 | 103 |
| Tm (° C.) | 146 | 149 | 140 | 147 | 151 | 139 |
| HE (FDA) | 1.7 | 2 | 2.9 | 3.5 | 3.5 | 4.6 |
| XS (FDA) | 3.8 | 4.3 | 8.6 | 6 | 6 | 10.9 |
| Izod @ 23° C. (ft-lb/in) | 1 | 1.3 | 1.8 | 1 | 1.6 | 1.6 |
| Flex Mod. (Kpsi) | 141 | 162 | 92 | 132 | 160 | 96 |
| Tensile Elong | 12 | 11 | 14 | 13 | 14 | 14 |
| @ Yield (%) | | | | | | |
| Tensile Str @ Yield | 4126 | 4180 | 3040 | 3883 | 4290 | 3145 |
| (psi) | | | | | | |

As demonstrated in the Table 1, random copolymers produced by TFC101 catalyst, which is embodied in accordance with present invention, demonstrates much lower hexane extractable (FDA method) at the same MFR and lower xylene soluble (FDA method) than commercially available copolymer. For example, when TFC101 catalyst produced propylene ethylene random copolymer having MFR is 11 with C2=3.4%, hexane extractable is 1.7% and xylene soluble is 3.8%, while commercial 1,3-diether catalyst produces propylene ethylene random copolymer having hexane extractable=3.5% and xylene soluble=6.0% with similar MFR (=11.0) and C2% (=3.3%). Also random copolymer having high C2%, TFC101 catalyst produced propylene ethylene random copolymer having hexane extractable=2.9% and xylene soluble=8.6% for polymers having MFR=6.4 and C2=5.3%, while commercial 1,3-diether catalyst produced propylene ethylene random copolymer having hexane extractable=4.6% & xylene soluble=10.9%. for similar MFR (=6.9) and C2% (=5.5%).

In another embodiment of the present invention, a phthalate free random copolymer of propylene with ethylene is provided, the copolymer having a melt flow rate in the range of about 6.0 to about 20 g/10 min; and an ethylene content in the range of about 3.0 to about 5.0% by weight; wherein the hexane extractable portion of the copolymer is less than 2.0%; and wherein the xylene soluble portion of the copolymer is less than 4.5%. The copolymer has a flexural modulus is in the range of about 140 to about 160 Kpsi.

In yet another embodiment of the present invention, a phthalate free random copolymer of propylene with ethylene is provided, the copolymer having a melt flow rate in the range of about 6.0 to about 20 g/10 min; and an ethylene content in the range of about 5.0 to about 6.0% by weight; wherein the hexane extractable portion of the copolymer is less than 3.0%; and wherein the xylene soluble portion of the copolymer is less than 9.0%. The copolymer has a flexural modulus is in the range of about 80 to about 90 Kpsi.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and sprit of the present invention.

What is claimed is:

1. A phthalate free random copolymer of propylene with ethylene, comprising:
melt flow rate in the range of about 6.0 to about 20 g/10 min; and
ethylene content in the range of about 3.0 to about 5.0% by weight;
wherein the hexane extractable portion of the copolymer is less than 2.0%; and
wherein the xylene soluble portion of the copolymer is less than 4.5%.

2. The copolymer of claim 1, wherein the flexural modulus is in the range of about 140 to about 160 Kpsi.

3. The copolymer of claim 1, wherein the copolymer is produced by a Ziegler-Natta catalysts system comprising:
(a) a solid catalyst component produced by contacting titanium chloride with magnesium compounds in the presence of one or more internal donors selected from 1,3-diether, urea, and carbonate ether compounds;
(b) an aluminum alkyl compound; and
(c) an external electron donor compound.

4. The copolymer of claim 3, wherein the alkyl aluminum compound has the formula AlR₃, where the R is an alkyl having 1 to 8 carbon atoms, and wherein the three R groups are the same or different.

5. The copolymer of claim 4, wherein the alkyl aluminum compound is triethyl aluminum (TEAL).

6. A phthalate free random copolymer of propylene with ethylene, comprising:
melt flow rate in the range of about 6.0 to about 20 g/10 min; and
ethylene content in the range of about 5.0 to about 6.0% by weight;
wherein the hexane extractable portion of the copolymer is less than 3.0%; and
wherein the xylene soluble portion of the copolymer is less than 9.0%.

7. A random copolymer according to claim 6, having a flexural modulus of any value in the range of 80 to 90 Kpsi.

8. The copolymer of claim 6, wherein the flexural modulus is in the range of about 140 to about 160 Kpsi.

9. The copolymer of claim 6, wherein the copolymer is produced by a Ziegler-Natta catalysts system comprising:
(a) a solid catalyst component produced by contacting titanium chloride with magnesium compounds in the presence of one or more internal donors selected from 1,3-diether, urea, and carbonate ether compounds;
(b) an aluminum alkyl compound; and
(c) an external electron donor compound.

10. The copolymer of claim 9, wherein the alkyl aluminum compound has the formula AlR₃, where the R is an alkyl having 1 to 8 carbon atoms, and wherein the three R groups are the same or different.

11. The copolymer of claim 10, wherein the alkyl aluminum compound is triethyl aluminum (TEAL).
